(19) United States
(12) Patent Application Publication
(10) Pub. No.: US 2014/0229558 A1
(43) Pub. Date: Aug. 14, 2014

(54) METHOD AND SYSTEM FOR POSTAL SERVICES INCORPORATING ELECTRONIC MAIL OPTIONS

(71) Applicant: Flextronics AP, LLC, San Jose, CA (US)

(72) Inventor: Christopher P. Ricci, Saratoga, CA (US)

(21) Appl. No.: 14/176,935

(22) Filed: Feb. 10, 2014

Related U.S. Application Data
(60) Provisional application No. 61/763,329, filed on Feb. 11, 2013.

(51) Int. Cl. H04L 12/58; G06Q 50/26

(52) U.S. Cl. CPC H04L 51/38; G06Q 50/26
USPC 709/206

(57) ABSTRACT

A system and method receive, by a postal service, non-electronic or electronic communication, convert, by the postal service, the non-electronic or electronic communication into the other of the non-electronic or electronic communication, and deliver or cause delivery, by the postal service, to a receiver of the other of the non-electronic or electronic communication.

### CROSS REFERENCE TO RELATED APPLICATION

The present application claims the benefits of U.S. Provisional Application Ser. No. 61/763,329, filed Feb. 11, 2013, entitled “METHOD AND SYSTEM FOR POSTAL SERVICES INCORPORATING ELECTRONIC MAIL OPTIONS”, which is incorporated herein by this reference in its entirety.

### FIELD

The present disclosure relates generally to communications systems, and more particularly, to a communication method and system within a postal service operation that incorporates electronic mail with standard postal service mail.

### BACKGROUND

Traditional governmental postal services still exist in nearly every country; however, because of the existence of electronic mail (e-mail) and competing private delivery services, the volume of postal services provided through government agencies continues to decrease.

It is well-known that e-mail can be a primary means of communication for many individuals and organizations. E-mail can be sent through both secure and unsecured computer servers. For unsecure e-mail, e-mail messages are sent from a workstation/mobile device, and the e-mail messages are passed electronically through one or more computer servers and routers until the messages reach their intended e-mail address destinations. More specifically, e-mail is one of the protocols included within the transport control protocol/Internet protocol (TCP/IP) suite of protocols. The message sender composes the electronic communication document, and system software separates the message into packets according to the selected transmission control protocol (TCP). Each message has its corresponding Internet e-mail address. A mail server computer converts the recipient's e-mail address into a numeric Internet protocol (IP) address by a query of the domain name of the e-mail address. Routers that are dispersed throughout the Internet read the IP address on an attached packet, and relay the packet towards their destination. The destination mail server places the transmitted packets in their original order according to the instructions in each data packet, and then stores the message in the recipients e-mail mailbox. Finally, the recipient's resident e-mail software is then capable of displaying the message. For secure electronic communication, the security of a particular e-mail message is established through the Secure Socket Layer (SSL), which is a key based encryption capability. When a user communicates with a secure server using SSL, the server uses its private key protocol to prove to the user's computer that it is the correct destination server, therefore preventing an intermediate computer from intercepting the electronic communication. The user's computer generates the automatic public key, and the destination server generates a confidential or secret key, which is sent to the user's computer for encryption of the public key. Accordingly, the user's computer and the destination server are capable of communicating using a symmetric key encryption with the shared secret key. Each e-mail created results in the generation of a unique secret key.

While e-mail may provide nearly instantaneous and secure means for communication, there are still many reasons for use of a traditional postal service. Although e-mails can generate a nearly limitless number of colors and designs for a particular message through associated word processing software, the e-mail is still sent and received in electronic form. Many forms of communication are still desirable to be received in tangible or “hard copy” form, such as a birthday, wedding, or anniversary cards/announcements. Further, some legal requirements still require the use of, or at least provide the option of, sending documents through a governmental postal service.

While it is presumed that most people have the capability to send and receive electronic communication at any time, there are many instances when a person may not have immediate access to a computer/mobile device, and therefore, the use of a traditional postal service must be used.

Therefore, while electronic mail may have certain benefits, there is still a need to provide traditional postal services in many instances. Further, while electronic mail may be a preferred means of communication, it would be advantageous to have the capability to generate hybrid communications in which a user could generate an e-mail with the intent for the message to be received in hard copy, and vice versa, in which the user may generate a hardcopy communication and wish for it to be delivered by e-mail.

### SUMMARY

These and other needs are addressed by the various aspects, embodiments, and/or configurations of the present disclosure. A method and system can be provided for postal services incorporating electronic communication options.

A method, system and computer readable medium are provided that can perform functions including:

(a) receiving, at a postal service and from a sender, a non-electronic or electronic communication to be delivered to a receiver;

(b) converting, by the postal service, the non-electronic or electronic communication into the other of the non-electronic or electronic communication; and

(c) delivering or causing delivery, by the postal service, to a receiver of the other of the non-electronic or electronic communication.

The sender, which is typically a private party and not part of (e.g., not employed by or otherwise associated with) the postal service, can address and write a communication, such as a letter, but in electronic form initially as an electronic communication. Custom software may be installed in the user's workstation/mobile device to provide functionality for generating the communication to include the postal address. The user can then forward the electronic communication to the postal service/facilitator with or without information regarding the receiver. Using information supplied with the electronic communication and/or an account of the sender and/or receiver, the postal service/facilitator then can create a hard copy mail document that includes the communication, the sender's return postal address, and the receiver's postal address. At this stage, the original electronic communication is therefore converted into a traditional piece of hard copy mail, and the postal service/facilitator then physically delivers the communication in the traditional manner to the addressed recipient.

The postal service can use presence information associated with the receiver to select a communication modality, channel, and/or electronic address for delivery of the electronic communication.

The postal service can alternatively or additionally use an account with the postal service associated with the sender and/or receiver to select a communication modality, channel, and/or electronic address for delivery of the electronic communication.

Traditional postal mail, referred to herein as a “hard copy” mail or communication, can alternatively be mailed by the sender to the postal service, converted into an electronic communication, and delivered to the receiver directly through electronic means, such as a computer workstation or mobile device. Accordingly, an original piece of hard copy mail can be delivered to the receiver as an electronic communication. The sender of the hard copy mail can send the piece of hard copy mail in a traditional manner, such as by dropping the hard copy document into a postal service mailbox. The postal service/facilitator would then inspect the piece of mail to determine if the recipient has an established electronic account with the postal service/facilitator and whether the particular type of hard copy document to be delivered qualifies as a type of mail document which could be converted to an electronic mail document. If a particular hard copy document being sent did not qualify as an electronic mail document, then the hard copy document would be sent through the traditional postal service channels and delivered in the original hardcopy form to the recipient. However, if the particular type of mail was one which qualified for conversion to an electronic document, the postal service would scan the document, and then generate an electronic communication to be received by the recipient's designated electronic communication address established in an address book function of the recipient's electronic account.

The postal service can select a delivery mechanism for the non-electronic communication based on a time and/or cost constraint or preference of the sender. The delivery mechanism can be one or more of delivery priority, delivery class, delivery cost, and delivery by courier.

The above described functionality can be achieved in a communication system in which the recipient had access to a workstation/mobile computing device, and the postal service/facilitator would also have its own computer workstation and/or server capability to electronically generate the electronic communication from the original hardcopy mail. The converted electronic communication is sent through the Internet, or through some other communications network, and preferably the electronic communication is sent as a secured electronic communication.

Both the user and sender of mail can select certain changes or upgrades to the particular type of communication being sent and received. For example, with respect to a sender who wishes to have a hardcopy piece of mail received from an electronically generated message, the sender could request that the postal service/facilitator deliver the communication on a particular type of paper or card stock, with color printing or other aesthetic options. In the event that the communication also requires the delivery of physical items associated with the communication, then both the sender and user could modify the particular communication means in which the physical items are ultimately received by regular mail procedures, but advanced notice is received by an electronic document in the form of an electronic communication.

The concepts of the present disclosure can also be used internally by the postal office to expedite mail delivery and lower operating costs. A method, system and computer readable medium are provided that can perform functions including:

(a) receiving, by a postal service and from a sender, a non-electronic or electronic communication to be delivered to a receiver;

(b) converting, by a first facility of the postal service, the non-electronic or electronic communication into the other of the non-electronic or electronic communication;

(c) transmitting the other of the non-electronic or electronic communication to a second facility of the postal service;

(d) converting, by the second facility of the postal service, the other of the non-electronic or electronic communication into the original non-electronic or electronic communication; and

(e) delivering or causing delivery, by the postal service, to the receiver of the original non-electronic or electronic communication.

The first facility is typically spatially nearer a residence and/or business of the customer than the second facility, and the second facility is typically spatially nearer a residence and/or business of the receiver than the first facility.

The present disclosure can provide a number of advantages depending on the particular aspect, embodiment, and/or configuration. The incorporation of electronic sending and receipt of traditional mail can be highly beneficial. For those types of communication which require sending through an official postal service, this modified form of mail delivery could still be deemed to satisfy necessary legal and other regulatory requirements. The process of delivering the mail communication can be simplified and made faster, since at least for mail delivered, it does not have to be manually delivered by mail carriers or handled by intermediate postal service infrastructure. Cost savings can also be realized by utilizing electronic capabilities.

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to electronic communication or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The term “database” refers to an organized collection of data. The data are typically organized to model relevant aspects of reality in a way that supports processes requiring this information.

The term “database management system” or DBMS refers to a specially designed application that interacts with the user, other applications, and the database itself to capture and analyze data. A general-purpose database management system (DBMS) is a software system designed to allow the definition, creation, querying, update, and administration of databases. Well-known DBMSs include MySQL™, MariaDB™, PostgreSQL™, SQLite™, Microsoft SQL Server™, Oracle, SAP™, dBASE™, FoxPro™, IBM DB2™, LibreOffice Base™ and FileMaker Pro™.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

The term “postal service” refers not only to a government or quasi-governmental mail delivery service, such as the United States Postal Service, but also to courier services. A postal service delivers messages, packages, and mail. Couriers are distinguished from ordinary mail delivery services by features such as speed, security, tracking, signature, specialization and individualization of express services, and swift delivery times, which are optional for most everyday mail services. Courier services operate on all scales, from within specific towns or cities, to regional, national and global services. Large courier companies include DHL™, FedEx™, EMS International™, TNT™, UPS™, SF Express™, YTO Express™, E-EMST™, Associated Air Services™, City Link Ltd.™, DX Group™, and Aramex™. These offer services worldwide, typically via a hub and spoke model.

The term “presence information” refers to a status indicator that conveys ability and willingness of a potential communication partner—for example a user—to communicate by specific communication channel or medium. For example, an intended message recipient may be available currently by a first communication channel or medium but unavailable on a second different communication channel or medium. A user's client provides presence information (presence state) via a network connection to a presence service, which is stored in what constitutes his personal availability record (called a presentity) and can be made available for distribution to other users (called watchers) to convey his availability for communication. Presence information is widely used in instant messaging or recent implementations of voice over IP clients. A common use of presence is to display an indicator icon on instant messaging clients, typically from a choice of graphic symbols with easy-to-convey meanings, and a list of corresponding text descriptions of each of the states. Even when technically not the same, the “on-hook” or “off-hook” state of called telephone is an analogy, as long as the caller receives a distinctive tone indicating unavailability or availability.

The term “presence service” refers to a network service which accepts, stores and distributes presence information.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a schematic diagram of the system of the disclosure;

FIG. 2 is a simplified flow diagram of the method of the disclosure;

FIG. 3 is a schematic diagram of the functional components of the system of FIG. 1; and

FIG. 4 is a flow diagram of another method of the disclosure.

### DETAILED DESCRIPTION

The present disclosure relates to communications systems and more particularly, to a communication method and system within a postal service operation that incorporates electronic mail with standard postal service mail. It can be considered a hybrid form of a communications network in which a user can choose to send and receive selectively communications, either in hard copy form or electronic form. A sender of a communication can generate a hard copy document (such as a letter, postcard, card, invitation, announcement, or other non-electronic document) and mail it as a priority, specified delivery class, courier, or standard rate postal letter but order the communication to be sent by the designated postal service/facilitator in electronic form, such as an e-mail, text, facsimile, and the like. A sender of a communication can generate an electronic communication, such as an e-mail, and order the electronic communication to be delivered as a hardcopy document. The postal service/facilitator incorporates both traditional postal service infrastructure as well as an electronic communications capability to securely send and receive electronic communications, such as e-mails.

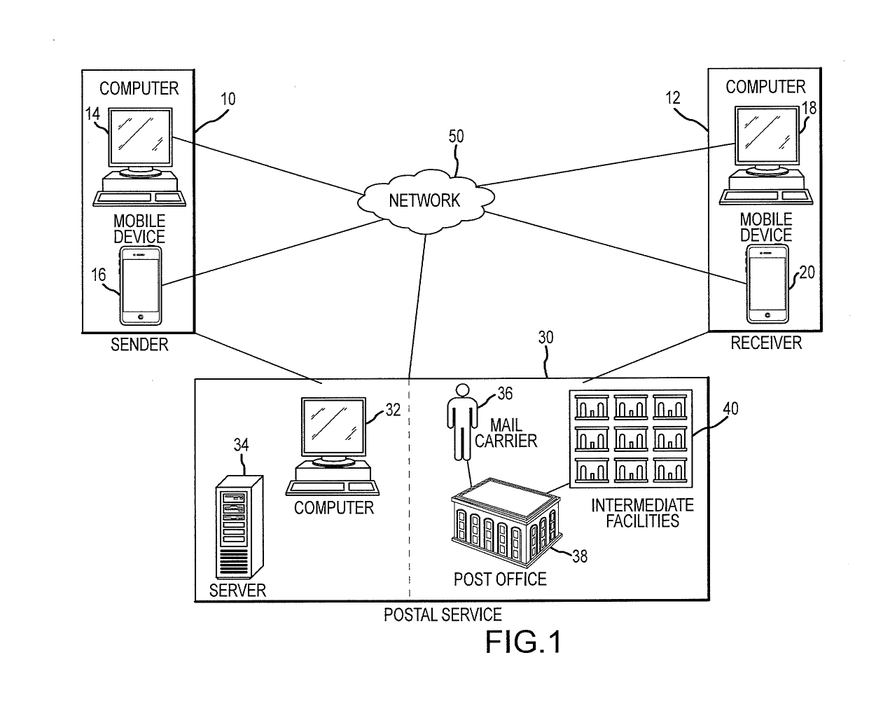

Referring to FIG. 1, a schematic diagram is provided for the system of the disclosure. As shown, the system comprises three primary components, namely, the sender 10, the receiver 12, and the postal service/facilitator 30. For the sender 10, this is intended to represent a person(s) or organization(s) who wishes to send a communication to the receiver, and the sender 10 has access to some type of computing device that may communicate through a distributed processing communications network 50, such as the Internet, or any other type of communications network including wide and/or local area networks, virtual private networks, etc. For the postal service 30, this is intended to represent either a governmental, quasi-governmental, or private mail handling service, or a combination of both. The example computing devices shown in the Figure for the sender 10 include a standard computer/workstation 14 and a mobile device 16. For the workstation 14, this element is intended to represent any number of standard computers, which have the capability to communicate through the communications network 50 (such as a personal computer, laptop computer, tablet computer, and the like), and the mobile device 16 is intended to represent any number of standard mobile communicating devices that have the capability to wirelessly communicate with the network 50 (such as a wireless phone, personal digital assistant, and the like). For the receiver 12, this is intended to represent a person(s) or organization(s) who wish to receive a communication from the sender, and the receiver also has its own workstation 18 and mobile device 20. For the receiver's workstation 18 and the receiver's mobile device 20, these elements are also intended to represent any number of standard computers and wireless mobile devices, respectively. According to the system of the disclosure, if the sender 10 wishes to generate a communication, the sender could choose simply to send the communication as a standard electronic communication in which the sender's computer or mobile device can generate the electronic communication, the electronic communication can be sent through the communications network 50, and the electronic communication can then received by the receiver's computer or mobile device. If however the sender wished to use the postal service 30 to send the receiver a hardcopy document, but initiated the correspondence as an electronic communication, the sender can utilize the electronic capabilities of the postal service to convert the electronic communication to a hardcopy letter. The sender can send a request or order in the form of an electronic communication to the postal service to initiate action by the postal service to generate a hardcopy document to be delivered to the intended receiver. The postal service has its own electronic communications capabilities, including the necessary number and type of computers 32 to receive the orders and to process the orders. The postal service 30 can also have its own mail servers 34 to handle the volume of incoming orders and outgoing electronic communications.

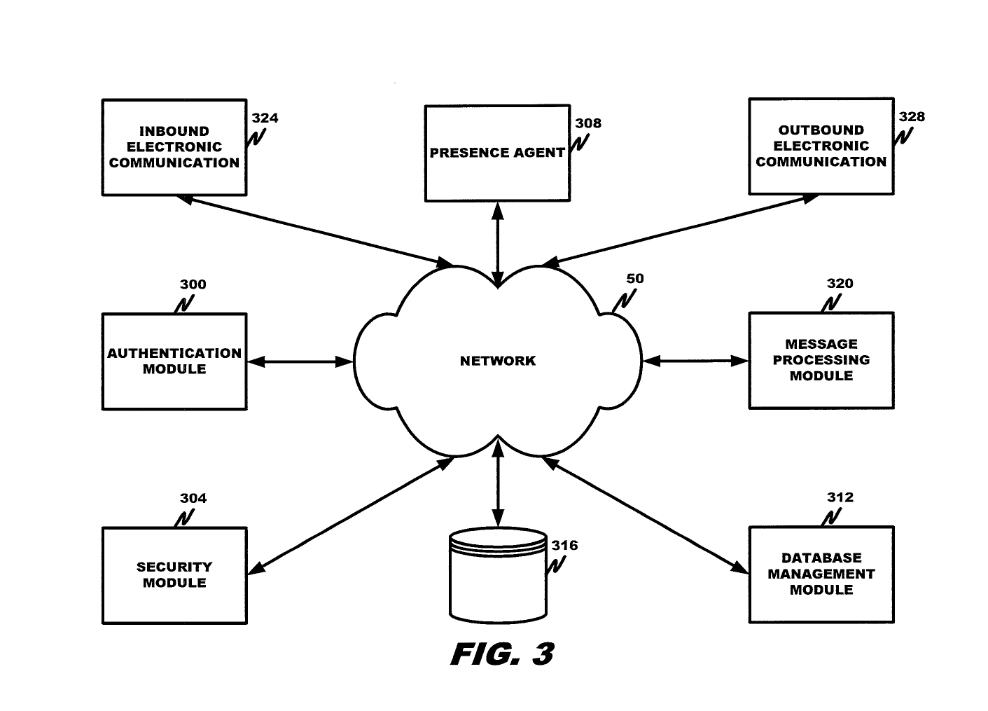

FIG. 3 provides a functional block diagram of a distributed processing system to provide these capabilities. The system includes an authentication module 300, security module 304, presence agent 308, database management module 312 and database 316, and a message processing module 320 to receive and/or send inbound and outbound electronic communications 324 and 328, respectively. These components are typically maintained at the postal service/facilitator 30.

The authentication module 300 authenticates the sender 10 or receiver 12 by any suitable technique, such as password-authenticated key exchange (such as encrypted key exchange (e.g., public key cryptography), multi-factor authentication, password authentication, OpenID, Needham-Schroeder protocol, JAVA Authentication and Authorization Service, the Point of Access for Providers of Information protocol, secure remote password protocol, SQRL, SSL, and the like.

The security module 304 encrypts and decrypts electronic communications. In an encryption scheme, the electronic communication or information (referred to as plaintext) is encrypted using an encryption algorithm, turning it into an unreadable ciphertext. This is usually done with the use of an encryption key, which specifies how the message is to be encoded. Any adversary that can see the ciphertext should not be able to determine anything about the original message. An authorized party, however, is able to decode the ciphertext using a decryption algorithm that usually requires a secret decryption key that adversaries do not have access to. An encryption scheme usually needs a key-generation algorithm to randomly produce keys.

The presence agent 308 provides presence information from a presence service (not shown) associated with the sender or receiver to the message processing module 320. The presence information indicates the various communication channels or modalities (e.g., email, instant messaging, cellular phone, wired phone, and the like) that can be used to contact the receiver and the state or status of the receiver on that channel or by that modality (e.g., on hook, off hook, online, offline, busy, and away).

The database management module 312 and database 312 maintain and provide data related to the sender, receiver, and processing of electronic communications. For example, the sender and/or receiver can establish an account with the postal service containing sender or receiver identification information (e.g., name, residence and/or business mailing address, contact information such as telephone numbers, email addresses, instant message handles, and the like) to enable the postal service to identify the sender or receiver as appropriate, authentication and other security information to enable the postal service to authenticate the sender or receiver as appropriate and encrypt and decrypt electronic communications, and sender or receiver preferences regarding how the sender or receiver desires to send hardcopy communications initiated by an inbound electronic communication 324 received by the postal office, how the sender or receiver desires to send an electronic communication or outbound electronic communication 328 initiated by a hardcopy communication received by the postal service, account holder preferences regarding communication modality or channel to be employed in sending the outbound electronic communication 328, account holder preferences regarding electronic or non-electronic communication formatting, content, and other aesthetic characteristics, and account holder preferences regarding delivery parameters such as delivery time requirements (generally or for specified receivers), delivery cost requirements (e.g., postage to be paid for hardcopy communications generally or for specified senders or receivers), and delivery class or delivery medium or means, such as first class, standard class, priority, courier, etc., to be used generally or for specified receivers. Stated differently, for a given user account different sets of senders to the user or receivers from the user can have differing preferences or requirements to be employed by the postal service.

The message processing module 320, using information received in or associated with the inbound electronic communication 324 or hardcopy communication, presence information for the receiver, and sender or receiver account information, and rules or policies (stored in database 316) determines how to process the inbound electronic communication 324. Processing the inbound electronic communication 324 or hardcopy message can include, for example, sending a hardcopy communication by a specified delivery class, rate, or priority of mail or courier, sending an outbound electronic communication 328 to one or more electronic addresses associated with the receiver, or some combination thereof. For example, an inbound electronic communication 324 can be sent to the receiver's office or home mailing address or both, by priority or standard or human courier delivery depending on sender and/or receiver preferences. An inbound hardcopy message can be sent to one or more electronic addresses of the receiver depending on sender and/or receiver preferences and presence information. Combinations of these actions can also be implemented in which a hardcopy letter and electronic communication are, in response to an inbound electronic communication 324 or received hardcopy letter, sent to the receiver. The hardcopy letter and electronic communication can contain the same, substantially similar and/or different information.

The sender has installed on his/her computer or mobile device software which can provide functionality for the sender's account to include all options as to how the electronically generated communication would be converted to a hardcopy document, and then ultimately delivered by the postal service to the receiver. Alternatively, the postal service can provide a web-based solution via the message processing module 320 and an account managed by the database management module 312/database 316. For example, the sender could have a host of options available to the sender with respect to the particular type of letter material, font, color, associated designs, etc. which would be selected by the user, and then created by the postal service after receiving an order from the sender to send a hardcopy communication or electronic communication. The order can be maintained in the database 316 for future use by the sender with respect to a different order. The sender can authorize various signature formats so that the delivered document appears to have an original signature, or one that has been at least verified and authorized by the sender. The sender can also provide the postal address for delivery of the communication, as part of the order or in a sender account so the postal service could then deliver the hardcopy letter.

Once the sender's order was received by the postal service 30, the postal service would convert the electronic message to a hardcopy document, such as a letter or convert a hardcopy document to an electronic communication. The message processing module 320 would determine the best location for the electronic communication to be converted to a hardcopy document or for the hardcopy document to be converted to an electronic communication, transmit the electronic communication or send the hardcopy document through its traditional postal service procedures to that location, and the postal service facility at that location would then prepare the appropriate hardcopy document or electronic communication as the case may be. For example, the postal service would have the necessary printing capabilities and printing supplies and/or scanning capabilities to accommodate the order from the sender. The postal service would then deliver the hardcopy document or communication through its traditional postal service procedures. As shown in FIG. 1, the standard postal service infrastructure includes mail carriers 36, post offices 38, and intermediate postal facilities 40, such as bulk mail centers, destination delivery units, processing and distribution centers, priority mail processing centers, bulk standard mail packaging services, etc. These intermediate facilities are used in their conventional purpose to allow distribution of the hardcopy communication to the receiver's postal address.

In the event a sender wishes to send cash, checks, or other forms of money, the postal service could convert these to electronic vouchers, which would represent a value for the original documents, thus making the funds available to the receiver in electronic form. This electronic voucher capability would incorporate the necessary banking rules, such as the current Check 21 Act. For example, the postal service could scan the original document, and the image of the document along with other security features could constitute the monetary voucher which the receiver could use to obtain the designated funds. The vouchers could be presented to any bank or other financial institution to be deposited or cashed. If the sender wished to utilize electronic capabilities of the postal service for sending funds, the sender would be made aware of certain policies regarding holding or destruction of original documents, and the creation of electronic vouchers in place of the original documents. For cash transfers, the postal service obviously would not destroy the cash, but would recycle the cash according to its internal cash receiving policies.

As noted, the sender can send an original hardcopy document through the postal service and have the hardcopy document delivered in electronic form. Preferably, the sender would have a pre-established account with the postal service regarding standard or special instructions for converting hardcopy documents to an electronic message. The sender would initiate the communication in the same manner in which the sender would normally use postal services by simply dropping the hardcopy document in a postal service mailbox. The document would be received at the local post office 38, or intermediate facilities 40, and then converted to an electronic message for sending by an appropriate communication modality or channel, such as e-mail, to the receiver. The particular post office/intermediate facility would have high-speed scanning capabilities to scan the document, and associate the receiver's electronic address with the receiver's postal address, or a pre-existing electronic address associated with the receiver who may also have an established account with the postal service. The postal service mail server 34 would then be used to send the now converted electronic message document through the communications network 50 and ultimately to the receiver's electronic communication application which would reside on either or both of the receiver's computer or mobile device. The receiver would have a number of options as to how the electronic form of the hardcopy document could be printed or saved in electronic form.

Both the sender and receiver who may wish to utilize the electronic capabilities of the postal service could establish their accounts such that there is a seamless transition between use of the postal addresses and electronic (message) addresses of the parties. For example, if the sender wished to send a piece of hardcopy mail to be received electronically, the sender would only be required to provide, for example, the receiver's postal address, and the postal service would have on record the associated electronic address of the receiver. Conversely, if the sender initiated a communication by electronic communication but wished for it to be delivered as a hardcopy document, the sender would only have to provide the electronic communication address of the receiver, and the postal service would have on record the associated postal address for delivery of the hardcopy document.

For situations in which the sender is sending both a hardcopy document and goods/products, the postal service would still deliver the goods/products through its traditional mail services, but the hardcopy document could be sent separately for delivery by electronic communication, which could therefore be used as an advanced notice to the receiver that the goods/products were to follow by regular mail.

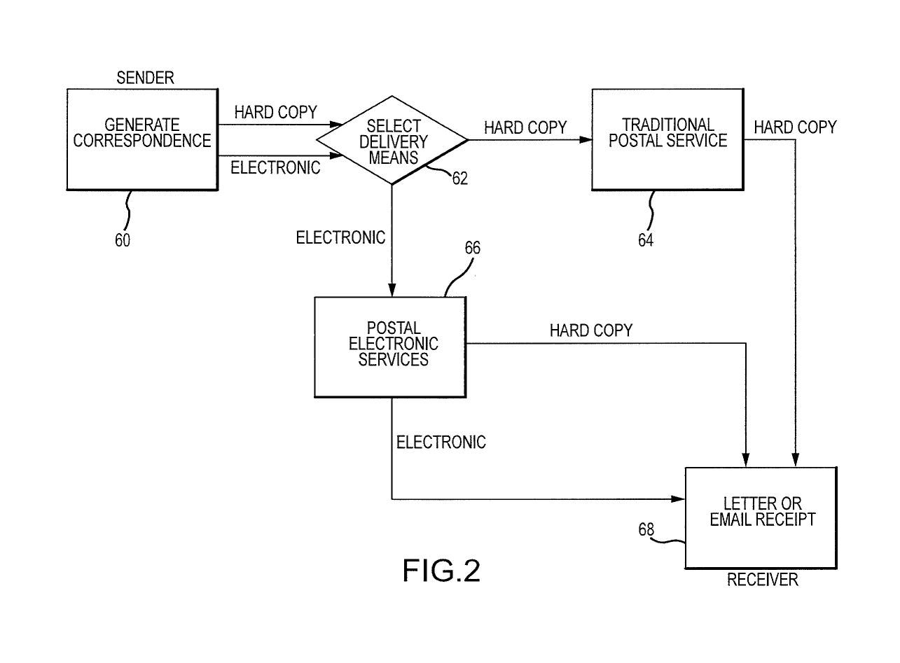

Referring to FIG. 2, a simplified schematic diagram is provided to illustrate the method of the disclosure. As shown in the Figure, the sender generates correspondence, shown at block 60. The correspondence is either in hard copy or electronic form. The sender then selects the delivery means at block 62. If the sender simply wishes the original hardcopy communication to be sent by regular mail, then traditional postal services are utilized, shown at block 64, in which the original hardcopy communication is delivered to the receiver at block 68. If the sender initiated a hardcopy communication, but wished for it to be delivered electronically to the receiver, the sender would therefore elect to utilize the postal electronic services, shown at block 66. Alternatively, if the sender initiated an electronic communication with the desire for it to be sent as a hardcopy communication, the sender would also utilize the postal electronic services represented by block 66; however, a portion of the traditional postal service would still be used, i.e., the infrastructure for actually delivering the communication; therefore, schematically a line could also be drawn to block 64 from block 66.

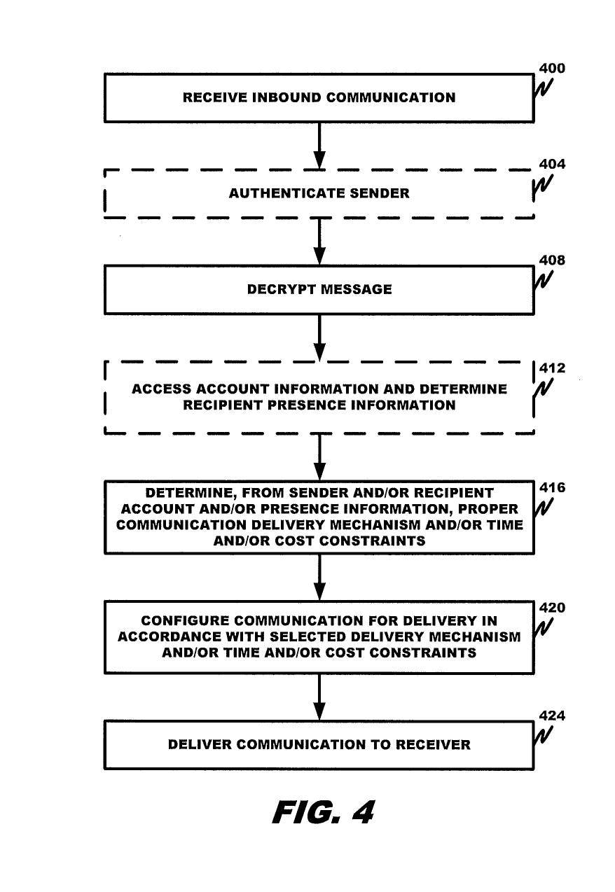

FIG. 4 is a schematic diagram according to another method of the disclosure.

In step 400, the postal service receives, from a sender, an inbound message, either in hardcopy (or non-electronic) or electronic form (e.g., inbound electronic communication 324).

In step 404, the authentication module 300 at the postal service authenticates the sender. If the sender is not authenticated successfully, the authentication module 300 provides an error message and logs the instance in association with the sender's account. If the sender is authenticated successfully, the authentication module 300 notifies the security module 304, which, in step 408 decrypts the message if required.

In optional step 412, the database management module 312 accesses the account of the sender and/or intended receiver to obtain account information, and the presence agent 308 accesses the presence service of the intended receiver to obtain presence information. The necessary information can be provided by an order from the sender in lieu of or in additional to step 412.

In step 416, the message processing module 320 determines first whether the inbound communication is eligible for conversion to a different form and, if so, second from the sender and/or recipient account and/or presence information and/or delivery information accompanying the inbound communication, a proper message delivery mechanism and/or time and/or cost constraints. For example, an inbound communication may be ineligible for electronic communication due to content of the non-electronic communication, format requirements of the non-electronic communication, privacy concerns of the customer, customer election, receiver preferences, inadequate receiver capabilities (e.g., no email address), and the like. If eligible, where cost is important to the sender but not date of delivery, standard or lower cost delivery service can be used for a selected hardcopy communication. Where time is important to the sender but not cost, higher priority or courier service can be used for a selected hardcopy communication. Where the communication to be delivered is an electronic communication, presence information associated with the receiver can be used to select an appropriate communication modality or channel for electronic communication delivery.

In step 420, the message processing module 320 configures the message (when an electronic communication) or causes configuration of the message (when a hardcopy communication) in accordance with the selected delivery mechanism and/or time and/or cost constraints and/or preferences of the sender and/or receiver.

In step 424, the message or communication is delivered to the receiver.

This method can also be configured to provide information to customs and a foreign postal service in the receiver's country in the case of international mail service. By providing to customs and/or the foreign postal service information regarding the hardcopy communication and/or goods shipped in association therewith or an electronic communication, passage through customs and/or delivery can be expedited.

The methods discussed herein can be highly beneficial for mass advertising or political campaigns. The advertiser or political office can forward a hardcopy communication or electronic communication to the postal service along with a spatial delivery requirement, such as a specification about a territory (e.g., set of zip or area codes, city, selected county, state, or province, and/or country, and the like) in which a mass mailing or message delivery is to occur. Alternatively, the advertiser or political office can provide a list of postal service customers with physical mailing and/or electronic address and/or delivery preference information. In the former case, the postal service can develop, based on publicly available and/or internal information, a list of receivers living and/or working within the spatial delivery requirement and, based on the account preferences of the sender and/or receiver, send either a non-electronic (e.g., hardcopy) communication or electronic communication or both. In the latter case, the postal service uses the list of receivers and, based on the account preferences of the sender and/or receiver, send either a hardcopy communication or electronic communication or both.

The exemplary systems and methods of this disclosure have been described in relation to a distributed processing system. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a computer, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the sender could initiate an electronic communication with the desire for it to be delivered electronically to the receiver, but sent through the postal electronic services as official electronic communication correspondence handled by the postal service. For various legal or regulatory requirements, it may be necessary for a communication to be handled by a secure electronic communication protocol of the postal service. Accordingly, the postal service would have its own designated secure communications network for receipt and sending of electronic communication communications.

In yet another embodiment, the conversion from non-electronic to electronic communications is used to help postal service performance and reduce operating costs. At a first postal service location, a non-electronic communication is received from a customer and reduced to an electronic communication. The electronic communication is sent to a distant, second postal service location where the electronic communication is converted, by the postal service, to a non-electronic communication and mailed through ordinary channel channels to the receiver. Intermediate handling of non-electronic communications can be reduced greatly and delivery to the receiver expedited. A reduced postal charge could be assessed by customer's consenting to this treatment for his or her non-electronic communication. This is so because the customer would be compromising his or her privacy by consenting to this procedure.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
receiving, by a postal service and from a sender, at least one of a non-electronic and electronic communication to be delivered to a receiver;
converting, by the postal service, the at least one of a non-electronic and electronic communication into the other of the at least one of a non-electronic and electronic communication; and
delivering or causing delivery, by the postal service, to the receiver of the other of the at least one of a non-electronic and electronic communication.

2. The method of claim 1, wherein the non-electronic document is at least one of a postcard and letter and the electronic communication is at least one of an email, instant message text, and facsimile.

3. The method of claim 1, wherein the at least one of a non-electronic and electronic communication is the non-electronic communication and the other of the at least one of a non-electronic and electronic communication is the electronic communication.

4. The method of claim 1, wherein the at least one of a non-electronic and electronic communication is the electronic communication and the other of the at least one of a non-electronic and electronic communication is the non-electronic communication.

5. The method of claim 3, wherein, in the converting step, the postal service, based on presence information associated with the receiver, selects at least one of a communication modality, channel, and electronic address for delivery of the electronic communication.

6. The method of claim 3, wherein, in the converting step, the postal service, based on an account with the postal service associated with the sender and/or receiver, presence information associated with the receiver, selects at least one of a communication modality, channel, and electronic address for delivery of the electronic communication.

7. The method of claim 4, wherein, in the converting step, the postal service selects a delivery mechanism for the non-electronic communication based on at least one of a time and/or cost constraint or preference of the sender.

8. The method of claim 7, wherein the delivery mechanism is one or more of delivery priority, delivery class, delivery cost, and delivery by courier.

9. A system, comprising:
a postal service facility to receive from a sender at least one of a non-electronic and electronic communication to be delivered to a receiver;
a microprocessor executable message processing module to convert the at least one of a non-electronic and electronic communication into the other of the at least one of a non-electronic and electronic communication for delivery by a postal service associated with the postal service facility; and
a postal service resource to deliver or cause delivery to the receiver of the other of the at least one of a non-electronic and electronic communication.

10. The system of claim 9, wherein the non-electronic document is at least one of a postcard and letter and the electronic communication is at least one of an email, instant message text, and facsimile.

11. The system of claim 9, wherein the at least one of a non-electronic and electronic communication is the non-electronic communication and the other of the at least one of a non-electronic and electronic communication is the electronic communication.

12. The system of claim 10, wherein the at least one of a non-electronic and electronic communication is the electronic communication and the other of the at least one of a non-electronic and electronic communication is the non-electronic communication.

13. The system of claim 11, wherein, in the converting step, the postal service, based on presence information associated with the receiver, selects at least one of a communication modality, channel, and electronic address for delivery of the electronic communication.

14. The system of claim 11, wherein, in the converting operation, the message processing module, based on an account with the postal service associated with the sender and/or receiver, presence information associated with the receiver, selects at least one of a communication modality, channel, and electronic address for delivery of the electronic communication.

15. The system of claim 12, wherein, in the converting operation, the message processing module selects a delivery mechanism for the non-electronic communication based on at least one of a time and/or cost constraint or preference of the sender.

16. The system of claim 15, wherein the delivery mechanism is one or more of delivery priority, delivery class, delivery cost, and delivery by courier.

17. A tangible and non-transient computer readable medium comprising microprocessor executable instructions that, when executed, perform steps including:
receiving from a sender at least one of a non-electronic and electronic communication to be delivered to a receiver;
converting the at least one of a non-electronic and electronic communication into the other of the at least one of a non-electronic and electronic communication; and
delivering or causing delivery to the receiver of the other of the at least one of a non-electronic and electronic communication.

18. The computer readable medium of claim 17, wherein the non-electronic document is at least one of a postcard and letter and the electronic communication is at least one of an email, instant message text, and facsimile.

19. The computer readable medium of claim 17, wherein the at least one of a non-electronic and electronic communication is the non-electronic communication and the other of the at least one of a non-electronic and electronic communication is the electronic communication.

20. The computer readable medium of claim 17, wherein the other of the non-electronic and electronic communication is delivered or caused to be delivered to multiple receivers based on a spatial delivery requirement of the sender.

21. A method comprising:
receiving, by a postal service and from a sender, at least one of a non-electronic and electronic communication to be delivered to a receiver;
converting, by a first facility of the postal service, the at least one of a non-electronic and electronic communication into the other of the at least one of a non-electronic and electronic communication;
transmitting the other of the at least one of a non-electronic and electronic communication to a second facility of the postal service;
converting, by the second facility of the postal service, the other of the at least one of a non-electronic and electronic communication into the at least one of a non-electronic and electronic communication; and
delivering or causing delivery, by the postal service, to the receiver of the at least one of a non-electronic and electronic communication.

22. The method of claim 21, wherein the first facility is nearer a residence and/or business of the customer than the second facility and wherein the second facility is nearer a residence and/or business of the receiver than the first facility.
